(19) United States
(12) Patent Application Publication
(10) Pub. No.: US 2025/0132834 A1
(43) Pub. Date: Apr. 24, 2025

(54) TRANSMISSION PATH MONITORING APPARATUS AND TRANSMISSION PATH MONITORING METHOD

(71) Applicant: Fujitsu Limited, Kawasaki-shi (JP)

(72) Inventors: Ryu SHINZAKI, Ota (JP); Shoichiro ODA, Fuchu (JP)

(73) Assignee: Fujitsu Limited, Kawasaki-shi (JP)

(21) Appl. No.: 18/885,025

(22) Filed: Sep. 13, 2024

(30) Foreign Application Priority Data
Oct. 19, 2023 (JP) 2023-180245

(51) Int. Cl. H04B 10/2543; H04B 10/2513

(52) U.S. Cl. CPC H04B 10/2543; H04B 10/2513

(57) ABSTRACT

A transmission path monitoring apparatus includes a memory configured to store an electric field signal that indicates an optical electric field component of an optical signal received from the optical transmission path, and a processor configured to generate predetermined information that includes optical powers of the optical signal at positions over the optical transmission path, based on the electric field signal and a specific signal that indicates an electric field and is obtained from demodulated data based on the electric field signal, and update the predetermined information, based on a first error between the electric field signal after compensating for linear distortion of the optical signal and nonlinear distortion of the optical signal based on the predetermined information and the specific signal, and a second error between differential amounts of the optical power at the positions and a reference value that includes a transmission loss of the optical transmission path.

### CROSS-REFERENCE TO RELATED APPLICATION

This application is based upon and claims the benefit of priority of the prior Japanese Patent Application No. 2023-180245, filed on Oct. 19, 2023, the entire contents of which are incorporated herein by reference.

### FIELD

An embodiment discussed herein is related to a transmission path monitoring apparatus and a transmission path monitoring method.

### BACKGROUND

A digital coherent optical transmission system including an optical transmission apparatus and an optical reception apparatus has been known. The optical reception apparatus performs coherent detection on an optical signal from an optical transmission path and receives the optical signal. The optical reception apparatus converts the received optical signal into an electric field signal for each polarization component, and compensates for degradation of each electric field signal due to, for example, wavelength dispersion of the optical transmission path and a nonlinear optical effect of the optical transmission path. An optical fiber having a length of, for example, several tens of kilometers to several thousands of kilometers extends as the optical transmission path between the optical transmission apparatus and the optical reception apparatus. One or a plurality of optical amplifiers may be provided over the optical transmission path. For maintenance management of such an optical transmission path, it is difficult for an operator to check a state of the entire optical transmission path. Thus, various techniques for monitoring the state of the optical transmission path have been proposed.

For example, digital longitudinal monitoring (DLM) based on a digital coherent optical transmission system has been proposed. The DLM is a technique for detecting characteristics of various devices (for example, an optical fiber, an optical amplifier, and the like) in the optical transmission system by digital signal processing on a reception side of the optical transmission system. The DLM monitors an optical power and the like, which are characteristics of the optical transmission path, by performing digital signal processing on an electric field signal obtained by coherent detection of the optical signal propagating along the optical transmission path.

Japanese Laid-open Patent Publication No. 2018-133725, U.S. Patent Application Publication No. 2018/0234184, Japanese Laid-open Patent Publication No. 2021-048542, U.S. Pat. No. 11,405,104, and International Publication Pamphlet No. WO 2023/139749 are disclosed as related art.

### SUMMARY

According to an aspect of the embodiments, a transmission path monitoring apparatus that monitors characteristics of an optical transmission path, the transmission path monitoring apparatus includes a memory configured to store an electric field signal that indicates an optical electric field component of an optical signal received from the optical transmission path, and a processor configured to generate predetermined information that includes optical powers of the optical signal at a plurality of positions over the optical transmission path, based on the electric field signal and a specific signal that indicates an electric field and is obtained from data obtained by demodulation based on the electric field signal, and update the predetermined information, based on a first error between the electric field signal after compensating for linear distortion of the optical signal and nonlinear distortion of the optical signal based on the predetermined information and the specific signal, and a second error between differential amounts of the optical power at the plurality of positions and a reference value that includes a transmission loss of the optical transmission path.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of an optical transmission system;

FIG. 2 is an example of an optical reception apparatus;

FIG. 3 is an example of a digital signal processor (DSP);

FIG. 4 is an example of an optical transmission path monitoring apparatus;

FIG. 5A is an example of an electric field signal;

FIG. 5B is an example of a reference signal;

FIG. 6 is an example of a profile generation unit;

FIG. 7 is an example of a nonlinear phase rotation amount distribution;

FIG. 8A is another example of the electric field signal;

FIG. 8B is an example of the reference signal;

FIG. 9 is an example of a differential amount distribution;

FIG. 10 is an example of a data storage unit;

FIG. 11 is an example of nonlinear phase rotation amount distributions before and after update;

FIG. 12 is an example of differential amount distributions before and after the update;

FIG. 13 is an example of a power profile;

FIG. 14 is a flowchart illustrating an example of an operation of the optical transmission path monitoring apparatus;

FIG. 15 is a diagram for describing an example of processing to be executed by a span detection unit;

FIG. 16 is a diagram for describing another example of the processing to be executed by the span detection unit; and

FIG. 17 is a flowchart illustrating an example of generation processing.

### DESCRIPTION OF EMBODIMENTS

Incidentally, in a case where the optical amplifier is provided over the optical transmission path, the optical transmission path is divided into a plurality of transmission sections by the optical amplifier. In this case, it may be said that the optical transmission path includes the plurality of transmission sections. By the digital signal processing on the reception side of the optical transmission system, in a case where the characteristics of the optical transmission path including such a plurality of transmission sections are estimated, the characteristics of the optical transmission path may not be estimated accurately. For example, a nonlinear phase rotation amount proportional to the optical power at each position in the optical transmission path may not be estimated accurately.

For example, when the characteristics of the optical transmission path are estimated, when the number of symbols (signal points) included in the electric field signal is small, the nonlinear phase rotation amount may vary due to noise caused by amplified spontaneous emission (ASE) generated in the optical transmission path. For example, in a case where the nonlinear phase rotation amount varies, the characteristics of the optical transmission path are not estimated accurately, and thus, it is difficult to calculate a wavelength dispersion coefficient to be used when a fiber type of the optical fiber is estimated.

Accordingly, to suppress the variation in the nonlinear phase rotation amount, for example, a method for smoothing the nonlinear phase rotation amount by moving average processing or the like is assumed. However, in this method, there is a possibility that the variation in the nonlinear phase rotation amount may not be completely suppressed, and there is a possibility that the characteristics of the optical transmission path may not be generated accurately.

For example, it is also assumed that the variation in the nonlinear phase rotation amount is suppressed by acquiring a large number of symbols such as several millions to several tens of millions and averaging the acquired symbols. However, in this case, there is a possibility that an acquisition time and a calculation load of the symbols increase.

Accordingly, in one aspect, it is an object to provide a transmission path monitoring apparatus and a transmission path monitoring method that estimate characteristics of an optical transmission path with a relatively small number of symbols.

Hereinafter, an embodiment of the present disclosure will be described with reference to the drawings.

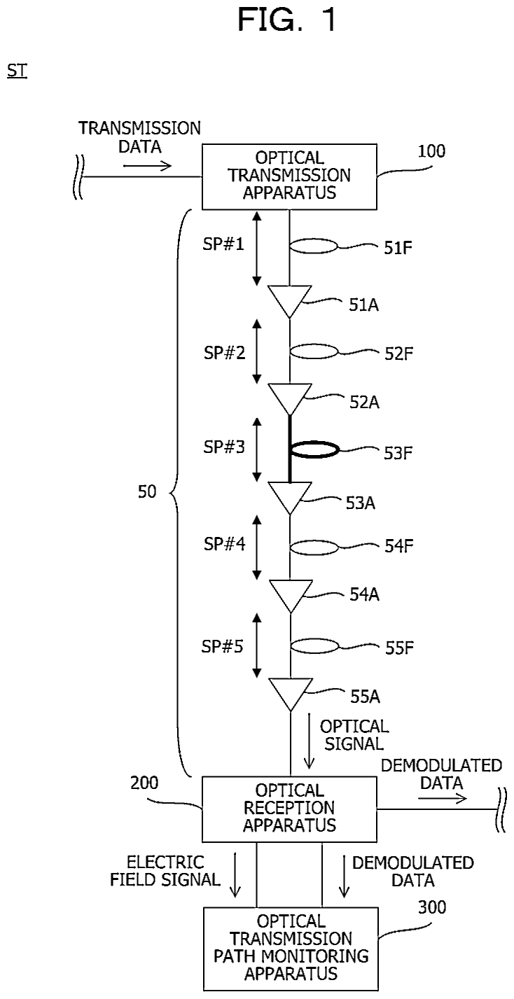

As illustrated in FIG. 1, an optical transmission system ST includes an optical transmission apparatus 100 and an optical reception apparatus 200. The optical transmission apparatus 100 and the optical reception apparatus 200 are coupled to each other by an optical transmission path 50. After transmission data is input, the optical transmission apparatus 100 transmits an optical signal obtained by modulating the transmission data to the optical transmission path 50. The optical signal propagates along the optical transmission path 50. The optical reception apparatus 200 receives, from the optical transmission path 50, the optical signal transmitted from the optical transmission apparatus 100, demodulates the optical signal, and outputs the demodulated data.

A plurality of optical amplifiers 51A, 52A, 53A, 54A, and 55A are provided over the optical transmission path 50. Thus, the optical transmission path 50 is divided into a plurality of transmission sections (hereafter, referred to as spans) SP #1, SP #2, SP #3, SP #4, and SP #5 by the optical amplifiers 51A, 52A, 53A, 54A, and 55A. For example, the optical transmission path 50 is a multi-span optical transmission path including the plurality of spans SP #1, SP #2, SP #3, SP #4, and SP #5 (hereafter, referred to as SP #1, . . . , and SP #5 as appropriate).

Various types of optical fibers 51F, 52F, 53F, 54F, and 55F are laid in the plurality of spans SP #1, . . . , and SP #5, respectively. For example, standard single mode fibers (SSMFs) are laid as the optical fibers in the spans SP #1, SP #2, SP #4, and SP #5. A non-zero dispersion shifted fiber (NZ-DSF) is laid as the optical fiber in the span SP #3.

Although lengths of the optical fibers 51F, 52F, 53F, 54F, and 55F are not particularly limited, in the present embodiment, as an example, the description will be given assuming that all the lengths of the optical fibers 51F, 52F, 53F, 54F, and 55F are 100 km (kilometers). For example, a path length of each of the plurality of spans SP #1, . . . , and SP #5 is 100 km, and a total path length obtained by summing up the individual path lengths is 500 km.

An optical transmission path monitoring apparatus 300 that is separate from the optical reception apparatus 200 is coupled to the optical reception apparatus 200. The optical transmission path monitoring apparatus 300 may be integrally included in the optical reception apparatus 200. The optical transmission path monitoring apparatus 300 is an example of a transmission path monitoring apparatus. The optical transmission path monitoring apparatus 300 monitors (performs monitoring of) characteristics of the optical transmission path 50. Although details will be described later, the optical transmission path monitoring apparatus 300 acquires, from the optical reception apparatus 200, an electric field signal indicating an optical electric field component of the optical signal received by the optical reception apparatus 200 and demodulated data obtained by demodulation based on this electric field signal.

After acquiring the electric field signal and the demodulated data, the optical transmission path monitoring apparatus 300 generates a power profile including optical powers of the optical signal at a plurality of positions over the optical transmission path 50 based on the electric field signal and the demodulated data. The power profile is an example of predetermined information and may represent the characteristics of the optical transmission path 50. As long as the power profile may be accurately generated, the optical transmission path monitoring apparatus 300 may accurately calculate a wavelength dispersion coefficient to be used for estimating a fiber type of the optical fiber based on the power profile.

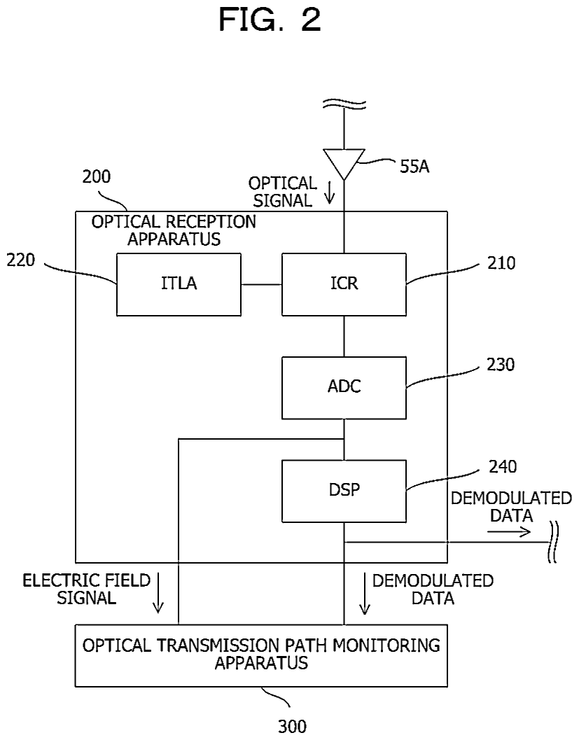

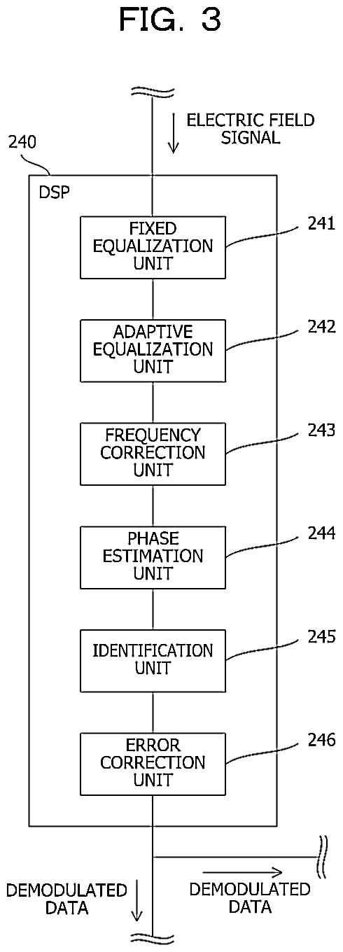

Next, details of the optical reception apparatus 200 will be described with reference to FIGS. 2 and 3.

The optical reception apparatus 200 includes an integrated coherent receiver (ICR) 210 and an integrable tunable laser assembly (ITLA) 220. Although not illustrated, a 90-degree optical hybrid circuit and a balanced photo diode (BPD) are included in the ICR 210. The ICR 210 is an integrated circuit including the 90-degree optical hybrid circuit and the BPD housed in one package. The optical reception apparatus 200 includes an analogue digital converter (ADC) 230 and a DSP 240.

The optical signal having passed through the optical amplifier 55A is input to the ICR 210. The ITLA 220 is a local oscillation light source that outputs local oscillation light (for example, laser beam). The ICR 210 receives the optical signal by the local oscillation light, converts the received optical signal into an electric field signal (for example, an electric field information signal) corresponding to the optical signal, and outputs the electric field signal to the ADC 230. The ADC 230 converts the electric field signal from an analog format to a digital format, and outputs the converted signal to each of the DSP 240 and the optical transmission path monitoring apparatus 300.

The DSP 240 receives the electric field signal output from the ADC 230 and executes various kinds of digital signal processing on the received electric field signal. As illustrated in FIG. 3, the DSP 240 includes a fixed equalization unit 241, an adaptive equalization unit 242, a frequency correction unit 243, a phase estimation unit 244, an identification unit 245, and an error correction unit 246.

The fixed equalization unit 241 compensates for wavelength dispersion on the optical signal propagating along the optical transmission path 50 with respect to the electric field signal received by the DSP 240. The fixed equalization unit 241 outputs, to the adaptive equalization unit 242, the electric field signal after compensating for the wavelength dispersion. The adaptive equalization unit 242 adaptively compensates for residual dispersion with respect to the electric field signal output from the fixed equalization unit 241. The residual dispersion is wavelength dispersion that remains without being compensated for by the fixed equalization unit 241. The adaptive equalization unit 242 outputs, to the frequency correction unit 243, the electric field signal after compensating for the residual dispersion.

The frequency correction unit 243 compensates for a frequency offset with respect to the electric field signal output from the adaptive equalization unit 242. The frequency offset is a difference (or deviation) between an optical frequency of a transmission light source (not illustrated) included in the optical transmission apparatus 100 and an optical frequency of the ITLA 220. The frequency correction unit 243 outputs, to the phase estimation unit 244, the electric field signal after compensating for the frequency offset. The phase estimation unit 244 compensates for a phase offset with respect to the electric field signal output from the frequency correction unit 243 and estimates a phase of the optical signal. The phase offset is a difference (or deviation) in the phase between the transmission light source and the ITLA 220. The phase offset is compensated for, and thus, the phase estimation unit 244 reproduces each symbol over constellation. The phase estimation unit 244 outputs a constellation map in which the symbols are reproduced to the identification unit 245.

Based on the constellation map output from the phase estimation unit 244, the identification unit 245 demodulates the transmission data by identifying a value of each symbol, and outputs the transmission data as the demodulated data to the error correction unit 246. The error correction unit 246 corrects a bit error of the demodulated data and outputs demodulated data after correcting the error.

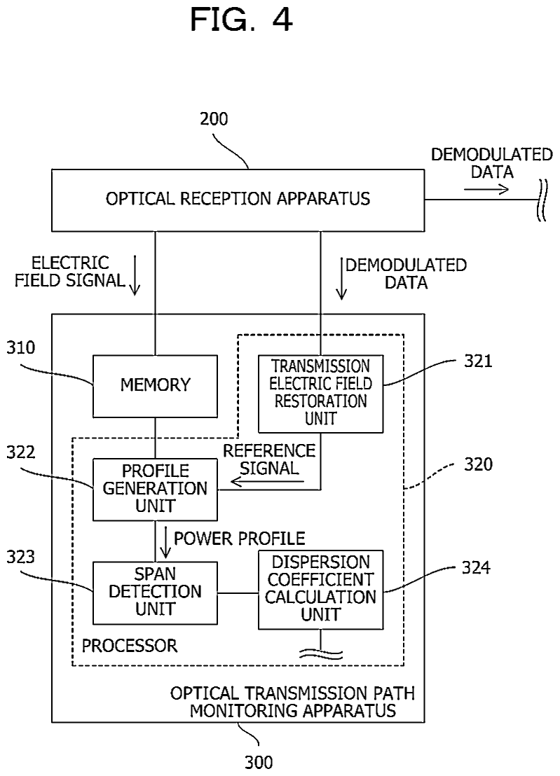

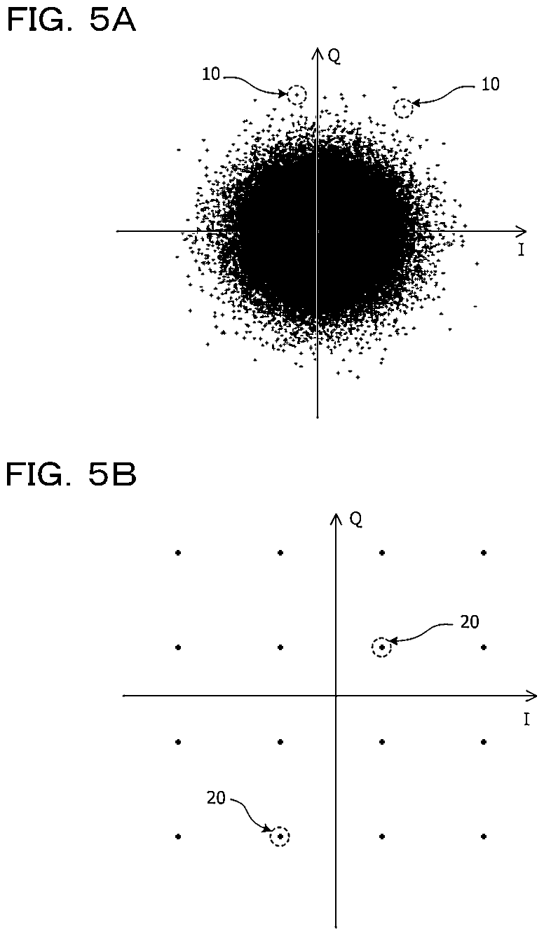

Next, details of the optical transmission path monitoring apparatus 300 will be described with reference to FIGS. 4, 5A, and 5B.

The optical transmission path monitoring apparatus 300 includes a memory 310 and a processor 320. The memory 310 temporarily stores the electric field signal output from the optical reception apparatus 200 (for example, the ADC 230). Accordingly, as illustrated in FIG. 5A, the memory 310 stores the electric field signal after being output from the ADC 230 and before being input to the DSP 240. The electric field signal includes an in-phase (I) component and a quadrature (Q) component of the optical signal received by the optical reception apparatus 200. In the electric field signal, a relatively small number (for example, about several tens of thousands) of symbols 10 corresponding to combinations of the I component and the Q component appear at various positions over the constellation map.

The processor 320 includes a transmission electric field restoration unit 321, a profile generation unit 322, a span detection unit 323, and a dispersion coefficient calculation unit 324. The transmission electric field restoration unit 321, the profile generation unit 322, the span detection unit 323, and the dispersion coefficient calculation unit 324 are realized by the processor 320 executing a program corresponding to flowcharts to be described later.

Based on the demodulated data output from the optical reception apparatus 200, the transmission electric field restoration unit 321 generates, as a reference signal, an electric field signal similar to the electric field signal generated by the optical transmission apparatus 100 based on the transmission data. For example, the reference signal is substantially the same as the electric field signal for generating the optical signal in the optical transmission apparatus 100. For example, as illustrated in FIG. 5B, the transmission electric field restoration unit 321 generates the reference signal by mapping symbols 20 corresponding to the demodulated data over the constellation map. After generating the reference signal, the transmission electric field restoration unit 321 outputs the reference signal to the profile generation unit 322. The reference signal is an example of a specific signal.

The profile generation unit 322 generates the power profile based on the electric field signal and the reference signal. After generating the power profile, the profile generation unit 322 outputs the power profile to the span detection unit 323. Details of the profile generation unit 322 will be described later.

Based on the power profile output from the profile generation unit 322, the span detection unit 323 detects the plurality of spans SP #1, . . . , and SP #5 included in the optical transmission path 50. For example, based on each of a plurality of peaks appearing in the power profile and peaks adjacent to each peak, the span detection unit 323 detects portions between the peaks as the spans SP #1, . . . , and SP #5. After detecting the plurality of spans SP #1, . . . , and SP #5, the span detection unit 323 outputs the plurality of detected spans SP #1, . . . , and SP #5 to the dispersion coefficient calculation unit 324.

The dispersion coefficient calculation unit 324 calculates a wavelength dispersion amount of each of the plurality of spans SP #1, . . . , and SP #5 output from the span detection unit 323. The wavelength dispersion amount corresponds to a difference between a cumulative wavelength dispersion amount at which a peak appears and a cumulative wavelength dispersion amount adjacent to that cumulative wavelength dispersion amount in the power profile. Based on the wavelength dispersion amount of each of the plurality of spans SP #1, . . . , and SP #5, the dispersion coefficient calculation unit 324 calculates the wavelength dispersion coefficient of each of the plurality of spans SP #1, . . . , and SP #5.

For example, the dispersion coefficient calculation unit 324 calculates the wavelength dispersion coefficient by dividing a dispersion amount estimated based on the power profile by a span length. The span length of each of the plurality of spans SP #1, . . . , and SP #5 is prepared in advance as span length data. After calculating the wavelength dispersion coefficient, the dispersion coefficient calculation unit 324 outputs the wavelength dispersion coefficient.

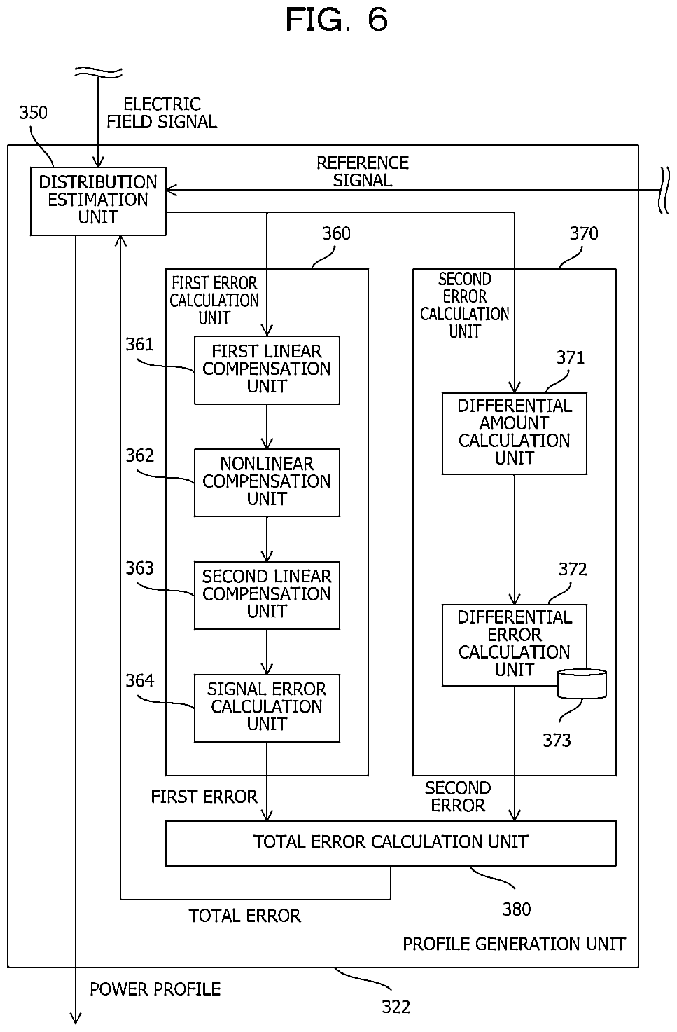

Next, details of the profile generation unit 322 described above will be described with reference to FIGS. 6 to 12.

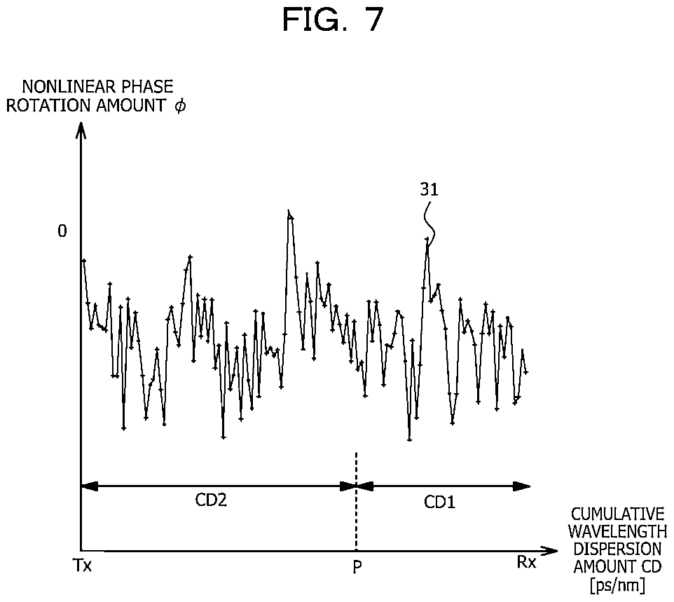

First, as illustrated in FIG. 6, the profile generation unit 322 includes a distribution estimation unit 350, a first error calculation unit 360, a second error calculation unit 370, and a total error calculation unit 380. The distribution estimation unit 350 is an example of a generation unit and an update unit, and estimates a nonlinear phase rotation amount distribution based on the electric field signal and the reference signal. For example, as illustrated in FIG. 7, the distribution estimation unit 350 estimates a nonlinear phase rotation amount distribution 31 based on the electric field signal, the reference signal, and an estimation algorithm for estimating the nonlinear phase rotation amount distribution from the electric field signal and the reference signal. For example, Takeo Sasai et al., “Proposal of Linear Least Squares for Fiber-Nonlinearity-Based Longitudinal Power Monitoring in Multi-Span Link”, 2022 27th OptoElectronics and Communications Conference (OECC) and 2022 International Conference on Photonics in Switching and Computing (PSC), Toyama, Japan, August. 2022, Takeo Sasai et al., “0.77-dB Anomaly Loss Localization Based on DSP-Based Fiber-Longitudinal Power Estimation Using Linear Least Squares”, 2023 Optical Fiber Communications Conference and Exhibition (OFC), San Diego, CA, USA, May. 2023, and Inwoong Kim et al., “Robust Longitudinal Power Profile Estimation in Optical Networks using MMSE with Complex Scaling Factor”, Optical Fiber Communication Conference 2023, San Diego, CA, USA, March. 2023 may be referred to for the estimation algorithm.

As illustrated in FIG. 7, a horizontal axis of the nonlinear phase rotation amount distribution 31 represents a cumulative wavelength dispersion amount CD (ps/nm) from the optical transmission apparatus 100 (denoted as Tx in FIG. 7) to the optical reception apparatus 200 (denoted as Rx in FIG. 7). The cumulative wavelength dispersion amount CD is a total amount of dispersion values of the wavelength dispersion on the optical signal propagating along the optical transmission path 50. Since the cumulative wavelength dispersion amount CD increases as the optical signal propagates along the optical transmission path 50, the cumulative wavelength dispersion amount CD corresponds to a distance of the optical transmission path 50.

On the other hand, a vertical axis of the nonlinear phase rotation amount distribution 31 represents a nonlinear phase rotation amount φ occurring in the optical transmission path 50. The nonlinear phase rotation amount φ is proportional to the optical power of the optical signal. As illustrated in FIG. 7, in the nonlinear phase rotation amount distribution 31, the nonlinear phase rotation amount φ at each position from the optical transmission apparatus 100 to the optical reception apparatus 200 greatly varies. As described above, the distribution estimation unit 350 estimates the nonlinear phase rotation amount distribution 31 based on the electric field signal including the large number of symbols 10 (see FIG. 5A) and the above-described reference signal (see FIG. 5B). However, based on these signals, in the nonlinear phase rotation amount distribution 31, the nonlinear phase rotation amount φ tends to greatly vary due to noise caused by ASE light, and as a result, a noisy state is obtained.

The first error calculation unit 360 calculates and outputs a first error. The first error is a signal error between the electric field signal after compensating for linear distortion and nonlinear distortion of the optical signal based on the nonlinear phase rotation amount distribution estimated by the distribution estimation unit 350 and the above-described reference signal. As illustrated in FIG. 6, the first error calculation unit 360 includes a first linear compensation unit 361, a nonlinear compensation unit 362, a second linear compensation unit 363, and a signal error calculation unit 364.

The first linear compensation unit 361 acquires the electric field signal from the distribution estimation unit 350, and converts an electric field signal in time domain into an electric field signal in frequency domain by Fourier transform. After the conversion into the electric field signal in the frequency domain, the first linear compensation unit 361 compensates for partial wavelength dispersion out of the wavelength dispersion generated in the optical transmission path 50 to compensate for the linear distortion of the optical signal with respect to the electric field signal.

For example, as illustrated in FIG. 7, the first linear compensation unit 361 acquires, as a dispersion compensation amount, a wavelength dispersion amount CD1 from a predetermined position P to the optical reception apparatus 200 in the nonlinear phase rotation amount distribution 31, out of the cumulative wavelength dispersion amount CD in the nonlinear phase rotation amount distribution 31. After acquiring the dispersion compensation amount, the first linear compensation unit 361 compensates for the wavelength dispersion by the dispersion compensation amount with respect to the electric field signal in the frequency domain. After compensating for the wavelength dispersion, the first linear compensation unit 361 converts the electric field signal in the frequency domain for which the compensation has been performed, into an electric field signal in the time domain by inverse Fourier transform and outputs the electric field signal in the time domain to the nonlinear compensation unit 362.

The nonlinear compensation unit 362 compensates for degradation due to a nonlinear optical effect of the optical transmission path 50 to compensate for the nonlinear distortion with respect to the electric field signal output from the first linear compensation unit 361. For example, the nonlinear compensation unit 362 compensates for the degradation due to the nonlinear optical effect based on the nonlinear phase rotation amount distribution estimated by the distribution estimation unit 350. The nonlinear compensation unit 362 outputs, to the second linear compensation unit 363, the electric field signal after compensating for the degradation due to the nonlinear optical effect.

The second linear compensation unit 363 converts the electric field signal in the time domain into the electric field signal in the frequency domain by Fourier transform with respect to the electric field signal output from the nonlinear compensation unit 362. After the conversion into the electric field signal in the frequency domain, the second linear compensation unit 363 compensates for the remaining part of the wavelength dispersion generated in the optical transmission path 50 to compensate for the linear distortion of the optical signal with respect to this electric field signal.

For example, as illustrated in FIG. 7, the second linear compensation unit 363 acquires, as the dispersion compensation amount, a wavelength dispersion amount CD2 from the optical transmission apparatus 100 to the predetermined position P in the nonlinear phase rotation amount distribution 31, out of the cumulative wavelength dispersion amount CD in the nonlinear phase rotation amount distribution 31. The wavelength dispersion amount CD2 corresponds to a difference obtained by subtracting the wavelength dispersion amount CD1 from the cumulative wavelength dispersion amount CD. After acquiring the dispersion compensation amount, the second linear compensation unit 363 compensates for the wavelength dispersion by the dispersion compensation amount with respect to the electric field signal in the frequency domain. After compensating for the wavelength dispersion, the second linear compensation unit 363 converts the electric field signal in the frequency domain for which the compensation has been performed, into an electric field signal in the time domain by inverse Fourier transform and outputs the electric field signal in the time domain to the signal error calculation unit 364.

The signal error calculation unit 364 calculates a signal error between the electric field signal compensated for by each of the first linear compensation unit 361, the nonlinear compensation unit 362, and the second linear compensation unit 363, and the reference signal transferred from the distribution estimation unit 350. The signal error calculation unit 364 may acquire the reference signal from the distribution estimation unit 350.

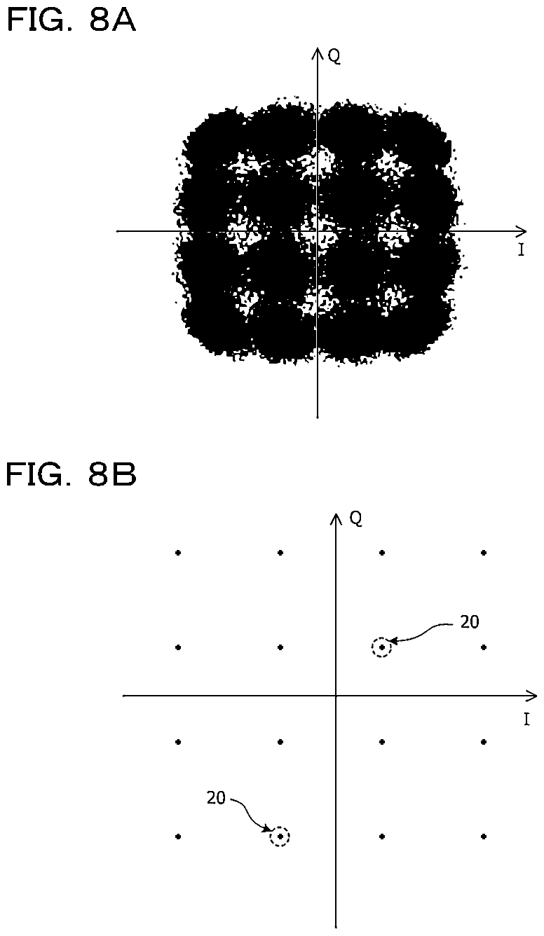

For example, as illustrated in FIG. 8A, in a case where the electric field signal after performing various kinds of compensation is input from the second linear compensation unit 363 to the signal error calculation unit 364, the signal error calculation unit 364 calculates the signal error between the electric field signal and the reference signal. As illustrated in FIG. 8B, the reference signal is generated by the transmission electric field restoration unit 321 mapping the symbols 20 corresponding to the demodulated data over the constellation map. For example, the reference signal is the same as the reference signal described with reference to FIG. 5B. The signal error calculation unit 364 calculates the signal error between such an electric field signal and the reference signal, and outputs, as the first error, the signal error to the total error calculation unit 380.

A degree of similarity between the corresponding symbols 10 and 20 between the electric field signal and the reference signal is measured, and thus, the signal error calculation unit 364 may calculate the signal error. For example, a method for least squares (for example, a sum of squares error), a residual sum of squares, or the like may be adopted for the measurement of the degree of similarity.

The magnitude of the degradation due to the nonlinear optical effect generated in the optical transmission path 50 (for example, nonlinear distortion) depends on the optical power of the optical signal. Accordingly, the magnitude of the degradation due to the nonlinear optical effect also depends on the nonlinear phase rotation amount proportional to the optical power of the optical signal. For example, as the nonlinear phase rotation amount is larger, the degradation due to the nonlinear optical effect is larger. The nonlinear compensation unit 362 according to the present embodiment is designed to compensate for the degradation due to the nonlinear optical effect generated when the nonlinear phase rotation amount is sufficiently large. For example, the nonlinear compensation unit 362 is designed to compensate for the degradation due to the nonlinear optical effect generated with respect to the optical power of the optical signal output by the optical transmission apparatus 100.

On the other hand, the signal error calculated by the signal error calculation unit 364 represents an error between the reference signal and the electric field signal after compensating for the wavelength dispersion (for example, linear distortion) and the degradation due to the nonlinear optical effect in the first error calculation unit 360. Accordingly, when the degradation due to the nonlinear optical effect is appropriately compensated for in the nonlinear compensation unit 362, the degree of similarity between the reference signal and the electric field signal after compensating for the wavelength dispersion and the degradation due to the nonlinear optical effect increases, and the signal error calculated by the signal error calculation unit 364 decreases.

The second error calculation unit 370 calculates and outputs a second error. The second error is a differential error between a differential amount of the nonlinear phase rotation amount and a predetermined differential amount reference value including a transmission loss of the optical transmission path 50. As illustrated in FIG. 6, the second error calculation unit 370 includes a differential amount calculation unit 371, a differential error calculation unit 372, and a data storage unit 373. The data storage unit 373 is associated with the differential error calculation unit 372. For example, the differential error calculation unit 372 is an example of a calculation unit.

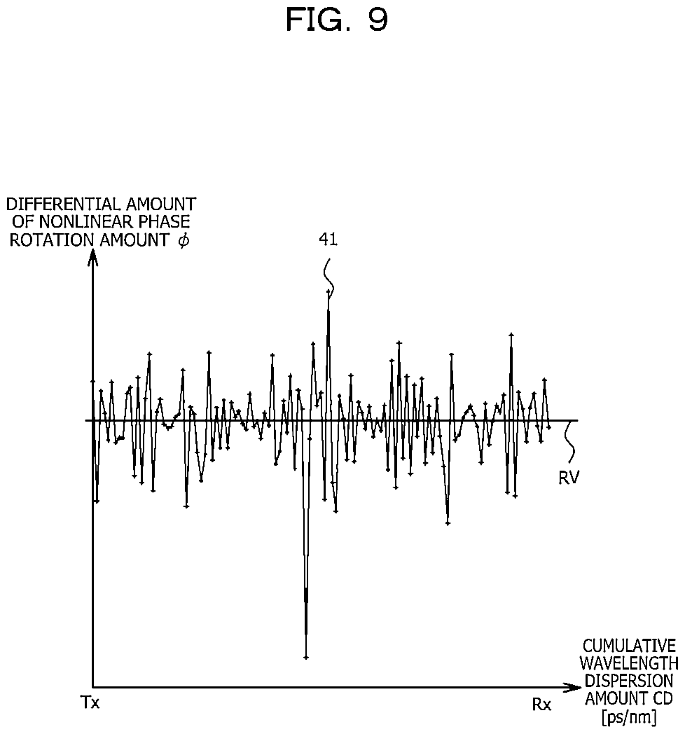

For the nonlinear phase rotation amount distribution 31 estimated by the distribution estimation unit 350, the differential amount calculation unit 371 calculates a differential amount of the nonlinear phase rotation amount φ for each position of the optical transmission path 50. Accordingly, as illustrated in FIG. 9, the differential amount calculation unit 371 generates a differential amount distribution 41 obtained by differentiating the nonlinear phase rotation amount distribution 31. When the nonlinear phase rotation amount φ at two positions adjacent to each other increases in an upward trend, the differential amount of the nonlinear phase rotation amount φ also increases. Conversely, when the nonlinear phase rotation amount φ at two positions adjacent to each other decreases in a downward trend, the differential amount of the nonlinear phase rotation amount φ also decreases.

The differential error calculation unit 372 calculates a differential error between the differential amount calculated by the differential amount calculation unit 371 and the above-described differential amount reference value, and outputs, as the second error, the calculated differential error to the total error calculation unit 380. The differential error calculation unit 372 calculates the differential amount reference value based on various kinds of data stored in the data storage unit 373, and calculates the differential error between the differential amount and the differential amount reference value.

The differential error calculation unit 372 may calculate the differential error by measuring a degree of similarity between the differential amount and the differential amount reference value in a common cumulative wavelength dispersion amount. For example, an L1 norm or the like may be adopted for the measurement of the degree of similarity.

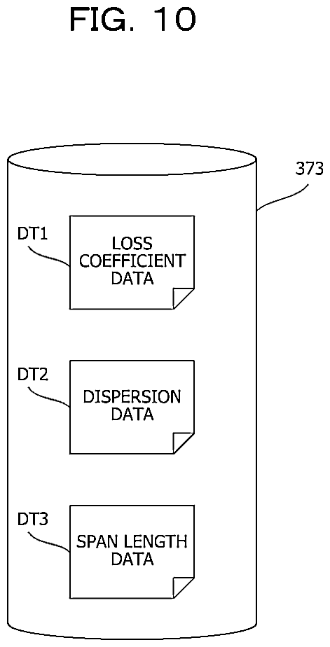

As illustrated in FIG. 10, loss coefficient data DT1, dispersion data DT2, and span length data DT3 are stored in advance in the data storage unit 373. In a case where the optical amplifier 51A, the optical amplifier 52A, or the like is provided in the optical transmission path 50, amplification data including a position and an amplification amount of the optical amplifier 51A, the optical amplifier 52A, or the like may be stored in the data storage unit 373.

The loss coefficient data DT1 include a loss coefficient at each position from the optical transmission apparatus 100 to the optical reception apparatus 200. For example, the loss coefficient data DT1 includes, as the loss coefficient, a transmission loss of 0.2 dB/km at each position. The loss coefficient is determined in advance based on a system design value of the optical transmission system ST.

The dispersion data DT2 includes a total wavelength dispersion amount from the optical transmission apparatus 100 to the optical reception apparatus 200. The total wavelength dispersion amount is measured and determined in advance. For example, the dispersion data DT2 includes a total wavelength dispersion amount “6800” (ps/nm). The span length data DT3 includes a length (or a distance) of each span, a total path length, and the like. For example, the span length data DT3 includes the length “100” (km) of each of the plurality of spans SP #1, . . . , and SP #5 and the total path length “500” (km).

Based on these pieces of data and Expression (1) below, the differential error calculation unit 372 calculates a differential amount reference value (dB/(ps/nm)).

$$Differential amount reference value = a / ( D / L ) \qquad ( 1 )$$

α represents a loss coefficient (dB/km) at each position. D represents a total wavelength dispersion amount (ps/nm). L represents a total path length (km).

For example, the differential error calculation unit 372 calculates-0.0147 (dB/(ps/nm)) as the differential amount reference value. A minus sign is given to the loss coefficient when the differential error calculation unit 372 calculates the differential amount reference value in consideration of the fact that the loss coefficient represents the loss. Thus, in FIG. 9, a differential amount reference value RV is illustrated near the differential amount “0” of the nonlinear phase rotation amount q. By using such a differential amount reference value RV, the differential error calculation unit 372 calculates the differential error between the differential amount calculated by the differential amount calculation unit 371 and the differential amount reference value, and outputs, as the second error, the calculated differential error to the total error calculation unit 380.

The total error calculation unit 380 calculates a total error based on the first error and the second error. For example, the total error calculation unit 380 calculates the total error obtained by summing up the first error and the second error. After calculating the total error, the total error calculation unit 380 outputs the total error to the distribution estimation unit 350.

After the total error is output from the total error calculation unit 380, the distribution estimation unit 350 determines whether or not this total error is less than a preset threshold value. In a case where the total error is not less than the threshold value, the distribution estimation unit 350 calculates a new dispersion compensation amount and a new nonlinear compensation amount by which the total error is minimized. Based on the calculated dispersion compensation amount and nonlinear compensation amount, the distribution estimation unit 350 updates the nonlinear phase rotation amount distribution, and calculates the total error again based on the updated nonlinear phase rotation amount distribution. As described above, the distribution estimation unit 350 continuously updates the nonlinear phase rotation amount distribution until the total error becomes less than the threshold value.

Thereafter, when the total error becomes less than the threshold value, the distribution estimation unit 350 generates the power profile based on the updated nonlinear phase rotation amount distribution, and outputs the generated power profile to the span detection unit 323. For example, when the distribution estimation unit 350 continuously updates the nonlinear phase rotation amount distribution, the total error may become less than the threshold value.

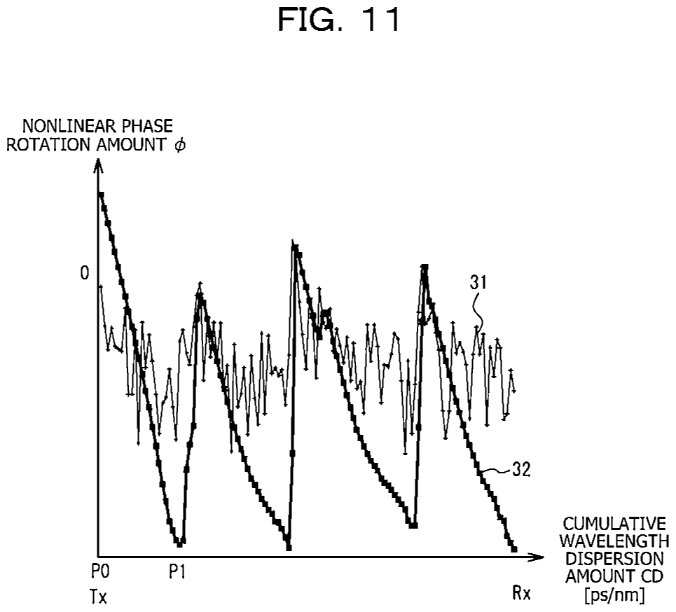

In this case, as illustrated in FIG. 11, the original nonlinear phase rotation amount distribution 31 in which the nonlinear phase rotation amount Q varies transitions to a nonlinear phase rotation amount distribution 32 corresponding to the nonlinear phase rotation amount φ proportional to the optical power of the optical signal propagating along the optical transmission path 50. In the nonlinear phase rotation amount distribution 32, for example, the nonlinear phase rotation amount φ proportional to the optical power decreases from a position P0 of the optical transmission apparatus 100 to a position P1 of the optical amplifier 51A. The nonlinear phase rotation amount distribution 32 indicates that the nonlinear phase rotation amount φ proportional to the optical power of the optical signal is rapidly increased by the optical amplifier 51A.

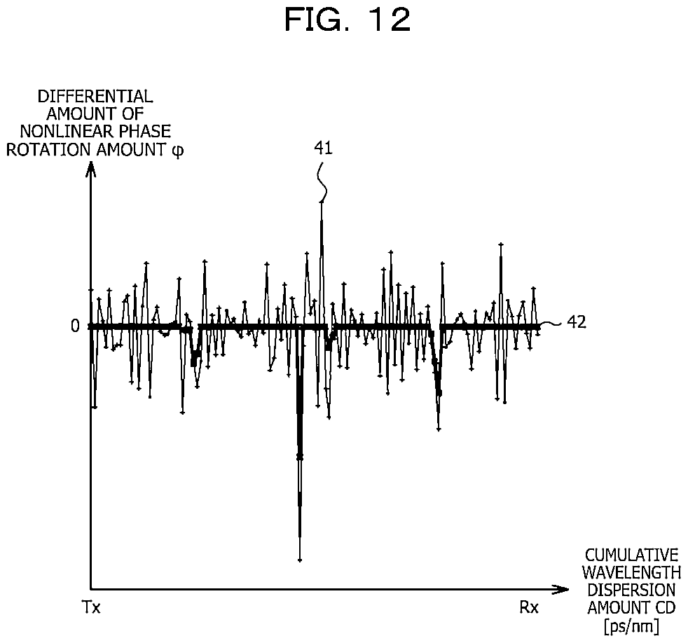

When the differential amount of the nonlinear phase rotation amount φ for each position of the optical transmission path 50 is calculated with respect to the nonlinear phase rotation amount distribution 32, as illustrated in FIG. 12, most of the original differential amount distribution 41 is updated to a new differential amount distribution 42 and is aggregated near the differential amount reference value RV. For example, this occurs because the nonlinear phase rotation amount φ linearly decreases from the position P0 of the optical transmission apparatus 100 to the position P1 of the optical amplifier 51A.

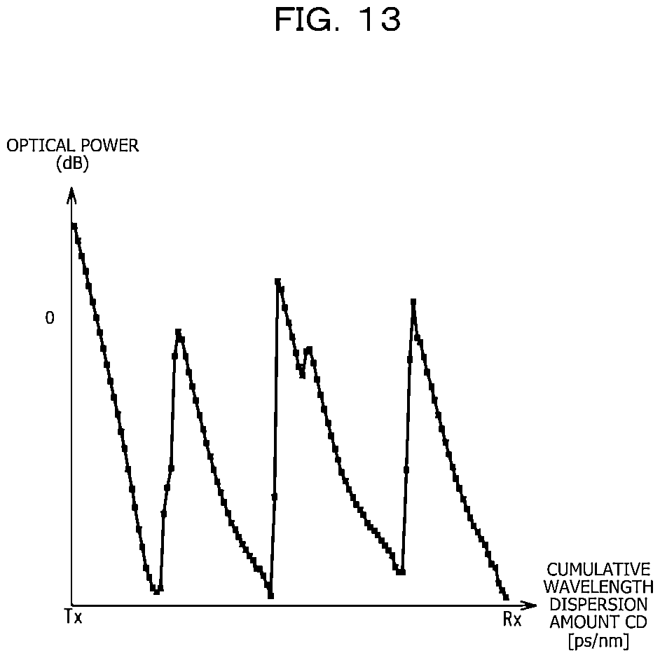

As described above, the distribution estimation unit 350 generates the power profile based on the updated nonlinear phase rotation amount distribution. For example, the distribution estimation unit 350 may generate the power profile by converting the nonlinear phase rotation amount φ designated on a vertical axis of the updated nonlinear phase rotation amount distribution into the optical power. For example, the nonlinear phase rotation amount distribution after the nonlinear phase rotation amount φ designated on the vertical axis is converted into the optical power may be output as the power profile. Accordingly, as illustrated in FIG. 13, the power profile is generated and output from the distribution estimation unit 350 to the span detection unit 323.

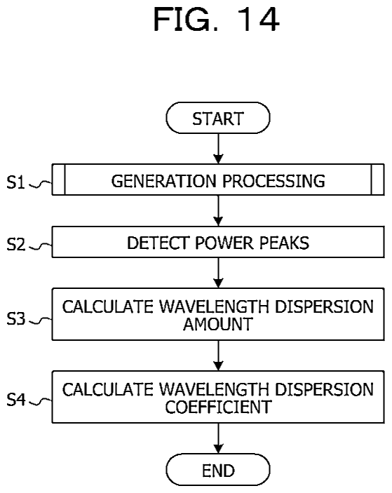

Next, the operation of the optical transmission path monitoring apparatus 300 will be described with reference to FIGS. 14 to 16.

First, as illustrated in FIG. 14, the profile generation unit 322 executes generation processing (step S1). The generation processing is processing of generating the power profile described above. Details of the generation processing will be described later. After the profile generation unit 322 ends the execution of the generation processing, the span detection unit 323 detects power peaks (step S2).

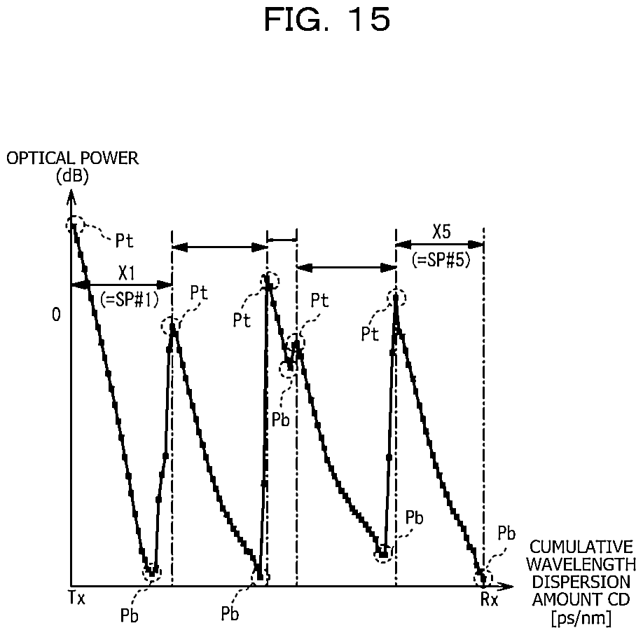

For example, as illustrated in FIG. 15, the span detection unit 323 detects power peaks Pt immediately before the optical power starts to decrease among a plurality of power peaks Pt and Pb of the optical power appearing in the power profile. For example, the power peaks Pb immediately before the optical power starts to increase are excluded from detection targets. After detecting the power peaks Pt, the span detection unit 323 specifies a portion corresponding to each of the spans SP #1, . . . , and SP #5.

For example, the span detection unit 323 specifies a section between two adjacent power peaks Pt as each of portions X1, . . . , and X5 corresponding to the spans SP #1, . . . , and SP #5. For example, the span detection unit 323 specifies, as the portion X1 corresponding to the span SP #1, a section between the power peak Pt having a smallest cumulative wavelength dispersion amount and the power peak Pt adjacent to this power peak Pt.

Referring back to FIG. 14, after detecting the power peaks, the span detection unit 323 calculates the wavelength dispersion amount (step S3). For example, the span detection unit 323 reads CD coordinates of the power peak corresponding to each of start ends of the spans SP #1, . . . , and SP #5, and calculates the wavelength dispersion amount for each of the spans SP #1, . . . , and SP #5.

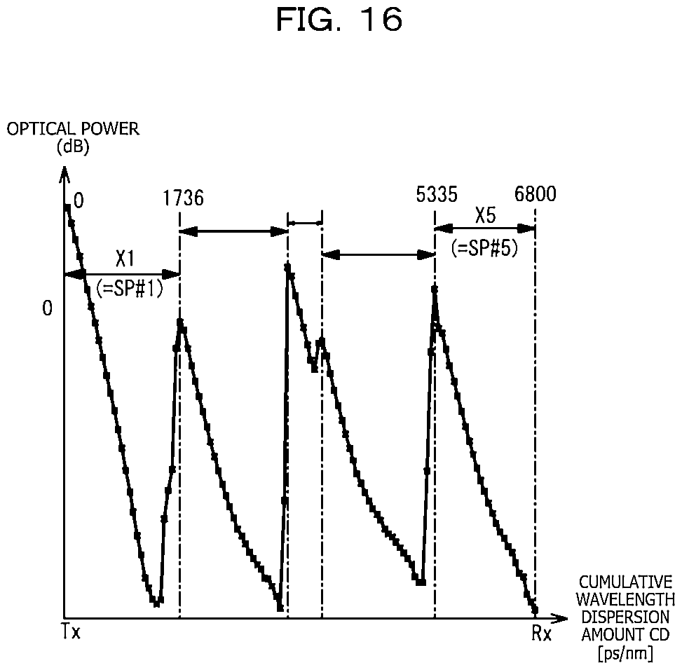

For example, as illustrated in FIG. 16, the span detection unit 323 reads CD “0” as CD coordinates corresponding to the start end of the span SP #1, and reads CD “1736” as CD coordinates corresponding to the start end of the span SP #2. The span detection unit 323 subtracts the CD “0” from the CD “1736”, and calculates a wavelength dispersion amount “1736” (ps/nm) of the span SP #1. Since the spans SP #2, . . . , and SP #4 (see FIG. 1) are basically similar to the case of the span SP #1, detailed description thereof will be omitted.

As for the span SP #5, the span detection unit 323 reads CD “5335” as CD coordinates corresponding to the start end of the span SP #5, but in the present embodiment, there are no CD coordinates corresponding to the start end of the span SP #6. In this case, the span detection unit 323 acquires the total wavelength dispersion amount “6800” (ps/nm) included in the dispersion data DT2 stored in the data storage unit 373, and uses this total wavelength dispersion amount as the CD-coordinates corresponding to the start end of the span SP #6. Accordingly, the span detection unit 323 subtracts CD “5335” from CD “6800”, and calculates a wavelength dispersion amount “1465” (ps/nm) of the span SP #5. As described above, the span detection unit 323 may calculate the wavelength dispersion amount for each of the spans SP #1, . . . , and SP #5.

Referring back to FIG. 14, when the span detection unit 323 calculates the wavelength dispersion amount, the dispersion coefficient calculation unit 324 calculates the wavelength dispersion coefficient (step S4). Then, the processing is ended. For example, the dispersion coefficient calculation unit 324 acquires the length of each of the spans SP #1, . . . , and SP #5 included in the span length data DT3 stored in the data storage unit 373, and calculates the wavelength dispersion coefficient based on these lengths.

For example, in the case of the span SP #1, the dispersion coefficient calculation unit 324 calculates a wavelength dispersion coefficient “17.36” (ps/nm/km) by dividing the wavelength dispersion amount “1736” (ps/nm) of the span SP #1 by the length “100” (km) of the span SP #1. In the case of the span SP #5, the dispersion coefficient calculation unit 324 calculates a wavelength dispersion coefficient “14.56” (ps/nm/km) by dividing the wavelength dispersion amount “1465” (ps/nm) of the span SP #5 by the length “100” (km) of the span SP #5.

As described above, the dispersion coefficient calculation unit 324 may calculate the wavelength dispersion coefficient for each of the spans SP #1, . . . , and SP #5, and may grasp the characteristics of each of the spans SP #1, . . . , and SP #5. Accordingly, for example, as long as the optical transmission path monitoring apparatus 300 retains a table for managing a relationship between the wavelength dispersion coefficient and the fiber type, the optical transmission path monitoring apparatus 300 may estimate the fiber type of each of the spans SP #1, . . . , and SP #5 from the wavelength dispersion coefficient.

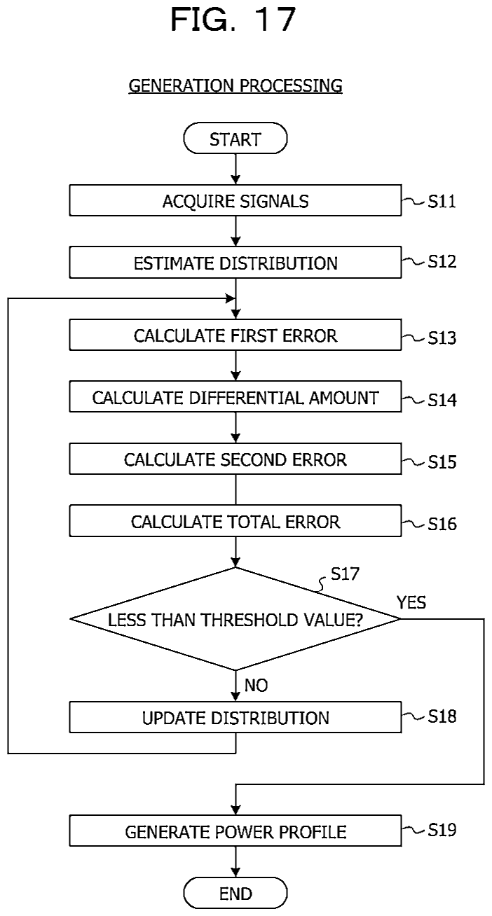

Details of the above-described generation processing executed by the profile generation unit 322 will be described with reference to FIG. 17.

First, the distribution estimation unit 350 acquires the electric field signal and the reference signal (step S11). After acquiring the electric field signal and the reference signal, the distribution estimation unit 350 estimates the nonlinear phase rotation amount distribution (see FIG. 7) (step S12). After the nonlinear phase rotation amount distribution is estimated, the first error calculation unit 360 calculates the first error (step S13). For example, the signal error calculation unit 364 acquires the electric field signal after the first linear compensation unit 361 compensates for a part of the linear distortion, the nonlinear compensation unit 362 compensates for the nonlinear distortion, and the second linear compensation unit 363 compensates for the remaining part of the linear distortion. After the signal error calculation unit 364 acquires the reference signal, the first error calculation unit 360 calculates the first error by calculating the signal error between the electric field signal after compensation and the reference signal.

After the first error is calculated, the second error calculation unit 370 calculates the differential amount (step S14) and calculates the second error (step S15). For example, the differential amount calculation unit 371 calculates the differential amount of the nonlinear phase rotation amount, the differential error calculation unit 372 calculates the differential amount reference value, and the second error calculation unit 370 calculates the second error by calculating the differential error between the differential amount and the differential amount reference value.

After the second error is calculated, the total error calculation unit 380 calculates the total error (step S16). After the total error is calculated, the distribution estimation unit 350 determines whether or not the total error is less than the threshold value (step S17). When the total error is equal to or greater than the threshold value (step S17: NO), the distribution estimation unit 350 updates the nonlinear phase rotation amount distribution (step S18), and repeatedly executes the processing of steps S13 to S17 until the total error becomes less than the threshold value. Accordingly, the nonlinear phase rotation amount distribution is updated such that the total error is less than the threshold value (see FIG. 11). When the total error is less than the threshold value, the distribution estimation unit 350 generates the power profile (step S19), and the generation processing is ended.

As described above, the optical transmission path monitoring apparatus 300 according to the present embodiment generates the power profile that represents the characteristics of the optical transmission path 50 in the multi-span optical transmission path including the plurality of spans SP #1, . . . , and SP #5. For example, the optical transmission path monitoring apparatus 300 generates the power profile based on not only the signal error described above but also the differential error between the differential amount appearing in the differential amount distribution obtained by differentiating the nonlinear phase rotation amount distribution and the differential amount reference value including the loss coefficient. Since the optical transmission path monitoring apparatus 300 generates the power profile based on such a differential error, the power profile may be generated accurately even though the number of symbols is relatively small.

Although the preferred embodiment of the present disclosure has been described in detail above, the present disclosure is not limited to the specific embodiment according to the present disclosure, and various modifications and changes may be made within a scope of the gist of the present disclosure described in the claims.

For example, by calculating the differential amount reference value using at least one of the position and the amplification amount of the optical amplifier together with the loss coefficient described above, the optical transmission path monitoring apparatus 300 may generate the power profile more accurately.

A nonvolatile memory that may be coupled to the optical transmission path monitoring apparatus 300 may be prepared, and a numerical value of the above-described loss coefficient (for example, a) and a numerical value of an average wavelength dispersion coefficient (for example, D/L) may be stored in advance in the same or different nonvolatile memories. In this case, the differential error calculation unit 372 may calculate a quotient obtained by dividing the loss coefficient by the average dispersion coefficient based on these two numerical values input from the nonvolatile memory. The distribution estimation unit 350 may set, as the differential amount reference value, this quotient calculated by the differential error calculation unit 372. On the other hand, the distribution estimation unit 350 may store such a quotient in the nonvolatile memory in advance. In this case, the distribution estimation unit 350 may set, as the differential amount reference value, the quotient stored in advance in the nonvolatile memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A transmission path monitoring apparatus that monitors characteristics of an optical transmission path, the transmission path monitoring apparatus comprising:
a memory configured to store an electric field signal that indicates an optical electric field component of an optical signal received from the optical transmission path; and
a processor configured to generate predetermined information that includes optical powers of the optical signal received from the optical transmission path at a plurality of positions over the optical transmission path, based on the electric field signal and a specific signal that indicates an electric field and is obtained from data obtained by demodulation based on the electric field signal, and update the predetermined information, based on a first error between the electric field signal after compensating for linear distortion of the optical signal and nonlinear distortion of the optical signal based on the predetermined information and the specific signal, and a second error between differential amounts of the optical power at the plurality of positions and a reference value that includes a transmission loss of the optical transmission path.

2. The transmission path monitoring apparatus according to claim 1, wherein the processor continuously updates the predetermined information until a sum of the first error and the second error becomes less than a threshold value.

3. The transmission path monitoring apparatus according to claim 1, wherein the processor updates the predetermined information based on a smallest sum of the first error and the second error.

4. The transmission path monitoring apparatus according to claim 1, wherein
the processor further configured to calculate the reference value, based on a loss coefficient that represents the transmission loss at each position of the plurality of positions, a total amount of dispersion values of wavelength dispersion generated in the optical transmission path, and a distance of the optical transmission path.

5. The transmission path monitoring apparatus according to claim 1, wherein the processor further configured to calculates a quotient obtained by dividing a loss coefficient stored in advance in a database by a dispersion values of wavelength dispersion per kilometer stored in advance in the database based on a value of the dispersion coefficient and a value of the loss coefficient, and set, as the reference value, the quotient or set, as the reference value, the quotient stored in advance in the database.

6. The transmission path monitoring apparatus according to claim 4, wherein
the processor calculates the reference value, further based on at least one of a position and an amplification amount of an optical amplifier provided over the optical transmission path.

7. The transmission path monitoring apparatus according to claim 4, wherein
the processor calculates each of a dispersion compensation amount and a nonlinear compensation amount by which a sum of the first error and the second error is minimized, and updates the predetermined information, based on the dispersion compensation amount and the nonlinear compensation amount.

8. The transmission path monitoring apparatus according to claim 1, wherein
the processor further configured to calculate the first error and the second error.

9. A transmission path monitoring method comprising process of:
generating predetermined information that includes optical powers of an optical signal received from the optical transmission path at a plurality of positions over the optical transmission path, based on an electric field signal that indicates an optical electric field component of the optical signal and a specific signal that indicates an electric field and is obtained from data obtained by demodulation based on the electric field signal; and
updating the predetermined information, based on a first error between the electric field signal after compensating for linear distortion of the optical signal and nonlinear distortion of the optical signal based on the predetermined information and the specific signal, and a second error between differential amounts of the optical power at the plurality of positions and a reference value that includes a transmission loss of the optical transmission path.

10. The transmission path monitoring method according to claim 9, wherein
the updating process updates the predetermined information until a sum of the first error and the second error becomes less than a threshold value.

11. The transmission path monitoring method according to claim 9, wherein
the updating process updates the predetermined information based on a smallest sum of the first error and the second error.

12. The transmission path monitoring method according to claim 9, further comprising process of:
calculating the reference value, based on a loss coefficient that represents the transmission loss at each position of the plurality of positions, a total amount of dispersion values of wavelength dispersion generated in the optical transmission path, and a distance of the optical transmission path.

13. The transmission path monitoring method according to claim 9, further comprising process of:
calculating a quotient obtained by dividing a loss coefficient stored in advance in a database by a dispersion coefficient stored in advance in the database based on a value of the dispersion values of wavelength dispersion per kilometer and a value of the loss coefficient, wherein
the updating process sets, as the reference value, the quotient calculated by the calculation unit or sets, as the reference value, the quotient stored in advance in the database.

14. The transmission path monitoring method according to claim 12, wherein
the calculation process calculates the reference value, further based on at least one of a position and an amplification amount of an optical amplifier provided over the optical transmission path.

15. The transmission path monitoring method according to claim 9, wherein
the updating process calculates each of a dispersion compensation amount and a nonlinear compensation amount by which a sum of the first error and the second error is minimized, and updates the predetermined information, based on the dispersion compensation amount and the nonlinear compensation amount.
